(19) United States
(12) Patent Application Publication
(10) Pub. No.: US 2008/0182932 A1
(43) Pub. Date: Jul. 31, 2008

(54) Biocatalytic polymerization of anti-oxidant-modified latex particulates

(76) Inventors: Zhang-Lin Zhou, Palo Alto, CA (US); Sivapackia Ganapathiappan, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/698,518

(22) Filed: Jan. 25, 2007

(51) Int. Cl. C08J 3/03

(52) U.S. Cl. 524/457

(57) ABSTRACT

The present invention is drawn to a method of preparing anti-oxidant-modified latex particulates, ink-jet inks, and coating compositions. The present invention is also drawn to related latexes and ink-jet inks. The method can include steps of generating an emulsion with a hydrophilic continuous phase and a hydrophobic discontinuous phase, wherein the hydrophobic discontinuous phase includes monomers for polymerization, at least one monomer being modified by an anti-oxidant moiety; and polymerizing the monomers in the hydrophobic discontinuous phase using a biocatalytic polymerization process.

### BACKGROUND OF THE INVENTION

Latex particulates obtained by emulsion polymerization have a variety of applications, such as for model colloids for calibration of instruments used to measure particle size, immobilization of biomolecules (such as proteins or peptides) on the surface of the particles, development of new types of immunoassay, and formation of films for printed inks, paint, and/or coating applications. Specifically, with respect to inks, there are a wide variety of known dye or pigment materials that are used in both commercial printing and non-commercial printing. These inks are generally water-based dye inks or water dispersed pigment inks. In general, ink-jet printing has a lot of advantages over laser-jet printing because of the low and vibrant image color that can be achieved. However, a major problem with ink-jet printing is that prints produced therefrom suffer from lower durability, e.g., lower light fastness and/or water fastness, than prints produced by laser-jet printers. By utilizing latexes within an ink or as an overcoat for an ink, these durability issues can be ameliorated to some degree.

Because of the wide application of use for latex particulates, such as in the ink-jet arts and other fields, improved latexes are currently being developed. Thus, it would be desirable to provide improved latex particulates that can be used for many applications, including ink-jet ink applications.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a colorant” includes reference to one or more of such materials.

Likewise, the use of plural referents does not necessarily imply the use of multiple compositions. For example, referring to monomers in the plural form does not necessarily mean that multiple monomer types are present, but that multiple actual monomer molecules of at least one type are present. Such a reference does not, however, preclude the presence of other monomer types.

As used herein, “liquid vehicle” includes liquid compositions that can be used to carry colorants and/or other materials to a substrate. Liquid vehicles are well known in the art, and a wide variety of ink vehicles may be used in accordance with embodiments of the present invention. Such liquid vehicles may include a mixture of a variety of different agents, including without limitation, surfactants, solvents, co-solvents, buffers, biocides, viscosity modifiers, sequestering agents, stabilizing agents, and water. The liquid vehicle can also carry other additives such as latex particulates and other polymers, latex particulates, UV curable materials, and/or plasticizers, in some embodiments.

“Colorant” can include dyes, pigments, and/or other particulates that may be suspended or solvated in a liquid vehicle in accordance with embodiments of the present invention. Dyes are typically water soluble, and therefore, can be desirable for use in some embodiments. However, pigments can also be used in some embodiments. Pigments that can be used include self-dispersed pigments and pigments that are dispersed with a separate dispersing agent. Self-dispersed pigments include those that have been chemically surface modified with a small molecule or a polymeric grouping. This chemical modification aids the pigment in becoming and/or substantially remaining dispersed in a liquid vehicle. The pigment can also be dispersed by separate material, such as a polymer, an oligomer, or a surfactant, within the liquid vehicle.

An “ink” or “ink-jet ink” refers to a solution or dispersion composition that can comprise a liquid vehicle and a colorant. The colorant can be a dye and/or a pigment. In accordance with embodiments of the present invention, the ink can also include as anti-oxidant-modified latex particulates. In another embodiment, an ink-jet ink might not include the anti-oxidant-modified latex particulates, but the latex can be formulated in a dispersion or solution that can be separately formulated and applied as an overcoat with respect to a printed ink-jet ink on a media substrate. Exemplary pigments include those from pigment dispersions that include a separate dispersing agent, or alternatively, self-dispersed pigments that include attached or closely associated small molecule or polymeric dispersants at the surface of the pigments.

“Biocatalytic polymerization” refers to a reaction process where vinyl monomer(s) is(are) polymerized using an enzyme under relatively mild conditions. The enzyme used for polymerization can be any oxidoreductase compound that can induce and/or promote polymerization of such vinyl monomers, including for example, horseradish peroxidase (HRP), soybean and/or other legume peroxidase, laccase, α-chymotrypsin, bilirubin oxidase, or the like.

The term “protected” or “protection” refers to the state of a functional group that is capped with or bonded to a moiety that allows an anti-oxidant-modified moiety of a monomer to undergo emulsion polymerization processes under standard conditions, and then can be uncapped or deprotected after polymerization to expose the anti-oxidant groups. It is noted that when using biocatalytic polymerization in accordance with embodiments of the present invention, protection is not typically required.

“Support forming monomers” refers to one or more monomer type that can be copolymerized with anti-oxidant-modified monomers to form the anti-oxidant-modified latex particulates in accordance with embodiments of the present invention. Support forming monomers can provide bulk properties to monomers, can be film forming monomers, or can provide other desirable properties, depending on the application for which the latex particulates are prepared. For example, in ink-jet applications, it may be desirable to select support forming monomers (for copolymerization with anti-oxidant-modified monomers) that have properties that promote the formation of films once the latex is printed on a media substrate. Alternatively, if it is desirable to form latex particulates for biological or chemical sensor applications, it may be desirable to maintain the bulk properties of the latex. Support forming monomers include any monomer used in a polymerization process that is not an anti-oxidant-modified monomer.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 0.01 to 2.0” should be interpreted to include not only the explicitly recited values of about 0.01 to about 2.0, but also include individual values and sub-ranges within the indicated range. Thus, included in this numerical range are individual values such as 0.5, 0.7, and 1.5, and sub-ranges such as from 0.5 to 1.7, 0.7 to 1.5, and from 1.0 to 1.5, etc. This same principle applies to ranges reciting only one numerical value. Furthermore, such an interpretation should apply regardless of the breadth of the range or the characteristics being described.

In accordance with these definitions, latex particulates can be prepared including anti-oxidant moieties incorporated therein. The particulates can improve ink light fastness compared to standard latex particulates, or can provide other benefits in other applications. Thus, a practical method is provided for preparation of such latex polymer particles with the anti-oxidants at least on the surface, where a biocatalytic route of polymerization is used to polymerize monomers that include the anti-oxidant moieties. Such preparations have been difficult to prepare under conventional chemical conditions. Traditionally, to introduce an anti-oxidant moiety into latex, protection the functional groups would occur prior to polymerization, and removal of the protection groups after polymerization would expose the anti-oxidants at the surface of the latex particulates. However, this general method often results to destruction of the latex polymers. Thus, in accordance with embodiments of the present invention, a newer and more efficient method is provided herein that can be used to make the latex polymer containing anti-oxidant moieties without this and other drawbacks.

With this in mind, a method of preparing anti-oxidant-modified latex particulates in a fluid suspension can comprise the step of generating an emulsion with a hydrophilic continuous phase and a hydrophobic discontinuous phase, wherein the hydrophobic discontinuous phase includes monomers for polymerization, at least one monomer being modified by an anti-oxidant moiety. An additional step includes polymerizing the monomers in the hydrophobic discontinuous phase using a biocatalytic polymerization process.

In another embodiment, a method of preparing an ink-jet ink can comprise the steps of generating an emulsion with a hydrophilic continuous phase and a hydrophobic discontinuous phase, wherein the hydrophobic discontinuous phase includes monomers for polymerization, at least one monomer being modified by an anti-oxidant moiety; and polymerizing the monomers in the hydrophobic discontinuous phase using a biocatalytic polymerization process. An additional step includes formulating the anti-oxidant-modified latex particulates in an ink-jet ink composition by combining the anti-oxidant-modified latex particulates with a colorant. Optionally, the hydrophilic continuous phase can be mixed with other ingredients to form a liquid vehicle for the ink-jet ink.

In another embodiment, a method of preparing a coating composition suitable for overcoating an ink-jet ink-produced image can comprise the steps of generating an emulsion with a hydrophilic continuous phase and a hydrophobic discontinuous phase, wherein the hydrophobic discontinuous phase includes monomers for polymerization, at least one monomer being modified by an anti-oxidant moiety; and polymerizing the monomers in the hydrophobic discontinuous phase using a biocatalytic polymerization process. An additional step can include formulating the anti-oxidant-modified latex particulates in an ink-jettable coating composition. Optionally, the hydrophilic continuous phase can be mixed with other ingredients to form a liquid vehicle for the coating composition.

In still another embodiment, a latex can comprise a liquid medium and anti-oxidant-modified latex particulates suspended in the liquid medium. The anti-oxidant-modified latex particulates can be prepared by a biocatalytic polymerization process, wherein at least one monomer used in the biocatalytic polymerization process is modified by an anti-oxidant moiety.

In accordance with these embodiments, various details are provided herein which are applicable to each of the method, the ink-jet ink, the coating composition, and the latex. Thus, discussion of details in the context of one embodiment is intended to be relevant to the other embodiments.

In one embodiment, the anti-oxidant moiety can be unprotected, which can result in a latex free from protectant groups in the fluid medium. On the other hand, when a biocatalytic polymerization process is carried out, often, there can be residual amounts of enzyme in the liquid medium or aqueous continuous phase after formation of the anti-oxidant-modified latex particulates. In another embodiment, the polymerizing step can be carried out in mild enough conditions such that no more than about 25 wt % of the monomer modified by the unprotected anti-oxidant moiety is transferred from the hydrophobic discontinuous phase to the hydrophilic continuous phase during polymerization.

By employing enzymes in the organic synthesis of latex particulates, several advantages may result. For example, catalysis under mild reaction conditions with regard to temperature, pressure, and pH can be achieved, which often leads to remarkable energy efficiency. High enantio-, region-, and/or chemo-selectivity as well as regulation of stereochemistry can be achieved, which can promote development of new reactions to functional compounds for new materials. Further, by using a nontoxic natural catalyst, there is ecological or “green” appeal and commercial benefit. Thus, in accordance with embodiments of the present invention, naturally occurring polymers can be produced in vivo or in vitro by enzymatic catalysis. For example, in vitro synthesis of polymers through a biocatalytic route, i.e. enzymatic catalysis, can provided a new synthetic strategy for useful polymers, most of which are very difficult to produce by conventional chemical catalysts. Furthermore, the enzymatic polymerizations may greatly contribute to global sustainability without depletion of resources by using non-petrochemical renewable resources as starting substrates of functional polymeric materials.

Exemplary process mechanisms for preparing such anti-oxidant-modified latex particulates are provided in Formulations 1 to 8 below. However, it is noted that these reaction schemes are merely exemplary.

Turning to Formula 1, a general preparative formulation is provided. Starting from a commercially available or readily accessible monomer which is modified with an anti-oxidant moiety, enzymatic polymerization without the need for protective moieties in mild conditions can give latex particulates as shown below.

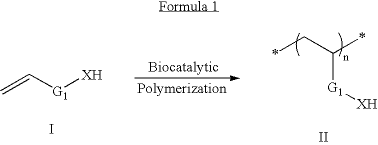

In Formula 1 above, G₁ represents a bridging group, which connects the polymerizable double bond of the monomer (I) with a reactive anti-oxidant functional group, XH, e.g., NH₂, SH, OH, etc. The bridging group can be any saturated or unsaturated hydrocarbon chain, such as alkyl, alkoxy, benzene, substituted benzene, ester, amide, etc., that will bridge the polymerizable double bond to the reactive group, but will not substantially interfere with polymerization. The letter n represents the number of monomer units in the polymer backbone larger than 2, but is typically from about 10 to about 5000. As mentioned above, biocatalytic polymerization is a reaction process where the monomer (I) is polymerized (usually with other co-monomers not shown in Formula 1) using an enzyme. The enzyme can be any oxidoreductase compound that can induce polymerization of such vinyl monomers, including for example, horseradish peroxidase (HRP), soybean and/or other legume peroxidase, laccase, α-chymotrypsin, bilirubin oxidase, or the like. For example, in one embodiment, a reaction utilizing HRP or another enzyme can be used with hydrogen peroxide and/or acetylacetone.

Formula 2 below sets forth a more specific molecular system with an —OH group as the reactive anti-oxidant functional group, as shown:

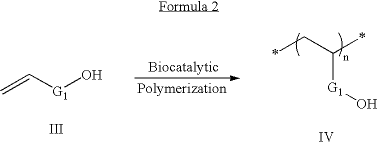

In Formula 2 above, G₁, n, and the discussion of Biocatalytic Polymerization can be the same as described with respect to Formula 1.

Formula 3 below sets forth another more specific molecular system with a —NR₁R₂ group as the reactive anti-oxidant functional group, as shown:

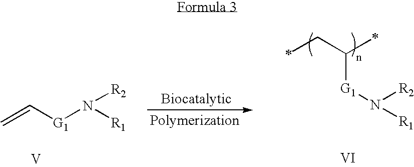

In Formula 3 above, G₁, n, and the discussion of Biocatalytic Polymerization can be the same as described with respect to Formula 1. Further, R₁ and R₂ independently represent hydrogen or branched or straight chained lower alkyl, e.g., C₁ to C₇.

Formula 4 below sets forth another specific molecular system, which contains hydroxyphenyl as a free radical scavenging group, which can be prepared, as shown:

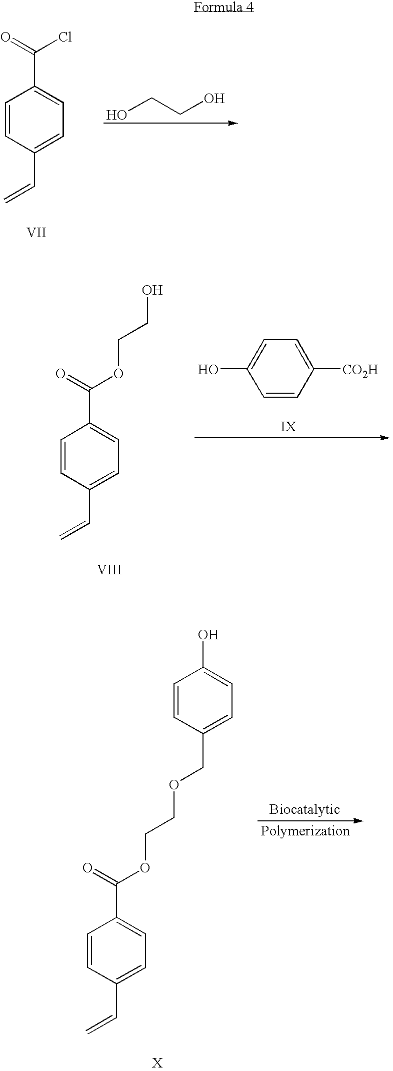

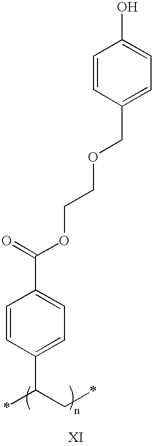

In Formula 4 above, n and discussion of Biocatalytic Polymerization can be the same as described with respect to Formula 1. Here, the reaction of 4-vinylbenzoic acid chloride (VII) with ethylene glycol to give a first monomer (VIII), which is further coupled with 4-hydroxybenzoic acid (IX) to give a second monomer (X). The second monomer (X) includes a polymerizable vinyl group and free radical scavenging 4-hydroxyphenyl group. Enzymatic polymerization of the second monomer without a protection group in mild conditions can give latex particulates (XI), which have an —OH anti-oxidant moiety on the latex surface. This latex is useful for improving light-fastness when these latexes are printed as overcoats or as additives with ink-jet inks.

Formula 5 below sets forth preparation of another specific molecular system, which contains N-methylpyrrolidine as free radical scavenging group, as shown:

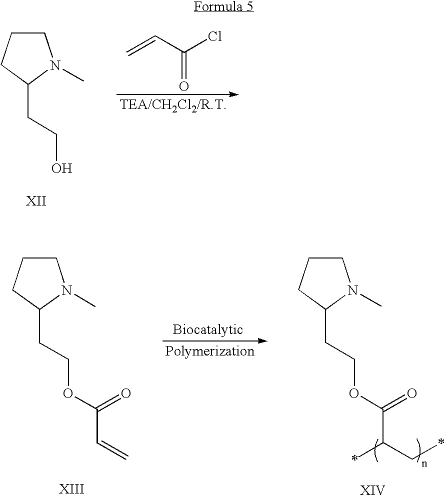

In Formula 5 above, n and discussion of Biocatalytic Polymerization can be the same as described with respect to Formula 1. Additionally, the reaction of 1-methyl-2-pyrrolidineethanol (XII) with acryloyl chloride can give a monomer (XIII), which has a polymerizable vinyl group and free radical scavenging N-methylpyrrolidine group. Enzymatic polymerization of the monomer without a protection group in mild conditions can generate latex particulates (XIV), which have an anti-oxidant moiety of tertiary amine on the latex surface. This latex is useful for improving light-fastness when formulated and printed as overcoats or as additives with ink-jet inks.

Formula 6 below sets forth the general preparation of another specific molecular system, which contains piperazine as free radical scavenging group, as shown:

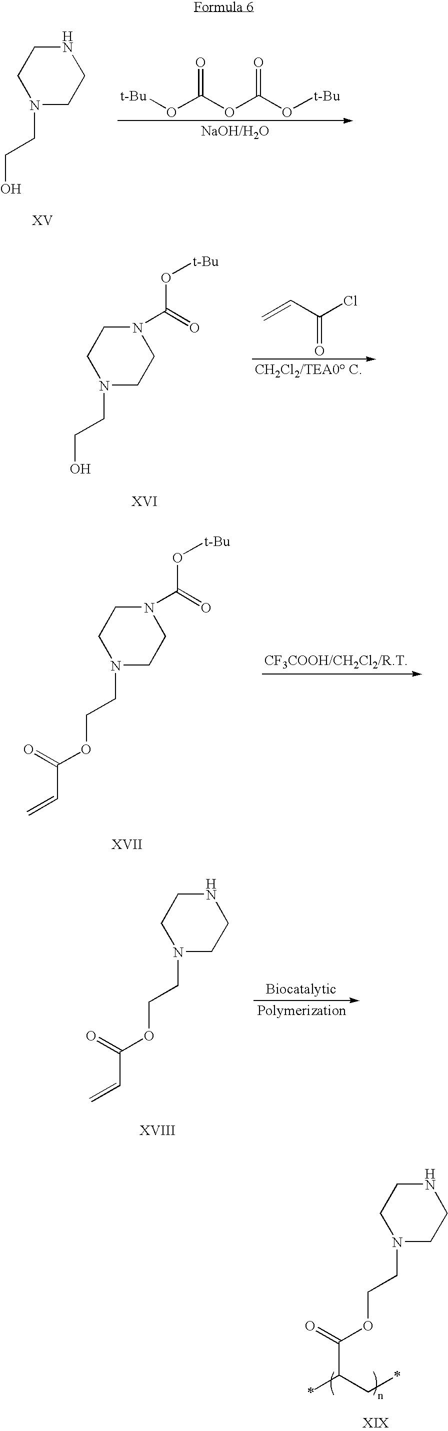

In Formula 6 above, n and discussion of Biocatalytic Polymerization can be the same as described with respect to Formula 1. Additionally, the reaction of 1-piperazineethanol (XV) with di-tert-butyl dicarbonate generates intermediate (XVI), which further reacts with acryloyl chloride to give a protected monomer (XVII). The protected monomer can then be deprotected by trifluoroacetic acid to give a second monomer (XVIII), which includes a polymerizable vinyl group and free radical scavenging piperazine group. Enzymatic polymerization of the second monomer without a protection group in mild conditions can generate latex particulates (XIX), which have anti-oxidant moiety, namely piperazine on the latex surface. This latex is useful for improving light-fastness when these latexes are formulated and printed as overcoats or as additives with ink-jet inks.

Formula 7 below sets forth another specific preparative scheme, which contains 4-hydroxyphenyl as free radical scavenging group, as shown:

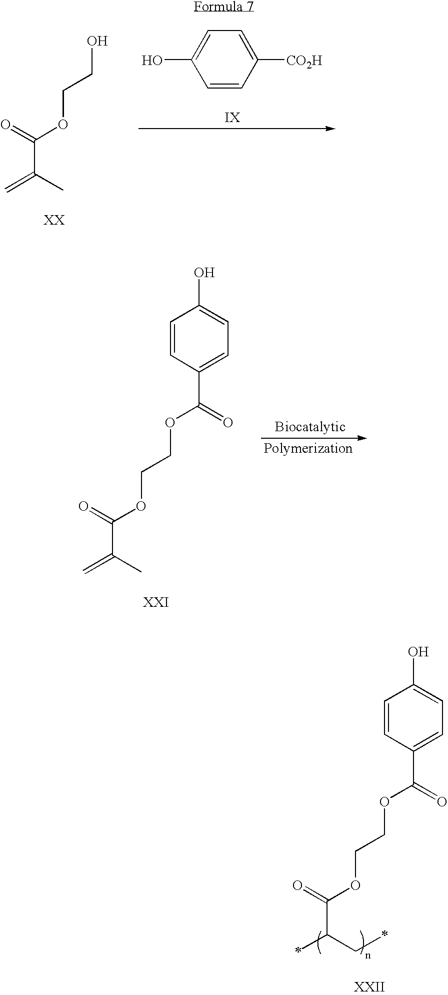

In Formula 7 above, n and discussion of Biocatalytic Polymerization can be the same as described with respect to Formula 1. Additionally, the reaction of ethylene glycol monomethylacrate (XX) with 4-hydroxybenzoic acid (IX) can generate a monomer (XXI), which contains a polymerizable vinyl group and free radical scavenging 4-hydroxyphenyl group. Enzymatic polymerization of the monomer without any protection in mild conditions can generate latex particulates (XXII), which have an -4-hydroxyphenyl anti-oxidant moiety on the latex surface, which is further useful for improving light-fastness when these latexes are printed as overcoats or as additives with ink-jet inks.

Formula 8 below sets forth another preparative scheme for a specific latex system, which contains 4-hydroxyphenyl as free radical scavenging group, as shown:

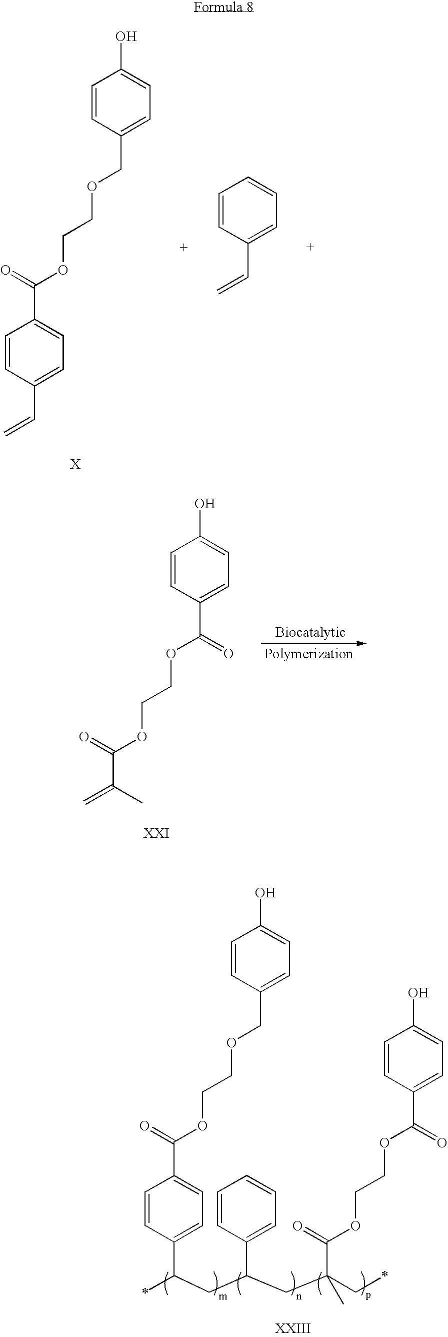

In Formula 8 above, m, n, and p can independently be the same as that described with respect to n in Example 1, and further, discussion of Biocatalytic Polymerization can be the same as described with respect to Formula 1. It is noted that m, n, and p are merely representative of the polymeric groups, and no order should be implied; and further, relative and total numbers of units can be polymer specific. The polymer shown is typically a random copolymer (though this is not required) and each group is present depending on the amount of each monomer added. For example, m+n+p can be at least 3, or from 10 to 5000. It is noted that other monomers (other than m, n, and p) can also be present which are not shown, including support monomers or film forming monomers. In another embodiment, m can be from about 1 to about 100; n can be from about 1 to about 100; and/or p can be from about 1 to about 100, Specifically, as shown in Formula 8, enzymatic co-polymerization of styrene as a support forming monomer with two anti-oxidant modified monomers (XXI) and (X) without protection groups in mild conditions can generate latex particulates XXIII, which have a -4-hydroxyphenyl anti-oxidant moiety (from two different monomers) on the latex surface. The latex can be useful for improving light-fastness when these latexes are formulated and printed as overcoats or as additives with ink-jet inks.

Though only shown in Formula 8, in each of the above Formulas, particularly in the ink-jet ink arts, support forming monomers can be used with the anti-oxidant-modified monomers that are shown. Exemplary support forming monomers include styrene, acrylic acid, acrylate monomers, methacrylic acid, methacrylate monomers, or the like. These can be copolymerized with the anti-oxidant-modified monomers to provide enhanced film forming properties. In other words, these support forming monomers can act to promote formation of a film upon printing the ink or coating on a media substrate. Such film forming properties can contribute to image permanence. Other monomers can alternatively be used which also have film forming properties, or which have other desirable properties, e.g., bulk properties.

The preparation of latex particulates in accordance with embodiments of the present invention can result in a latex emulsion having latex particulates of a weight average molecular weight from 5,000 Mw to 5,000,000 Mw. This range is only exemplary and can be broader, as indicated by the number of monomers described in Formulas 1 to 8 above. Further, though generally random copolymers are shown, various types of polymers can be formed, including block copolymers, randomly assembled copolymers, copolymers including crosslinkers, or the like. Still further, monomers with other types of functional groups can be copolymerized with other monomers with or without functional groups at various ratios to provide various results. If a crosslinking agent is used to crosslink a polymer, the application of use of the resultant latex particulate can be considered. For example, if the latex particulate is to be used in an ink-jet printing system, then from 0.1 wt % to 10 wt % of the crosslinking agent can be present with the monomers and copolymerized therewith.

As stated previously, ink-jet inks or coatings that can be prepared and used in accordance with embodiments of the present invention can include a liquid vehicle and a colorant, and optionally, anti-oxidant-modified latex particulates. Alternatively, the anti-oxidant-modified latex particulates can be jetted as an overcoat to an ink printed on a media substrate. For example, if no colorant is used, the latex can be admixed with other components to form an ink-jettable colorless solution or dispersion which can be applied as a protective coating material. In this embodiment, typically, an ink-jet ink can be jetted onto a substrate to produce an image, and the ink-jettable colorless solution can be overprinted with respect to the printed image for protection. In one of either of these embodiments, the colorant can be a dye or a pigment, such as a cyan, magenta, yellow, black, orange, pink, blue, gray, etc., dye or pigment. Further, the colorant can be present in the ink-jet ink at from 1 wt % to 10 wt %, or any incremental range therein.

The anti-oxidant-modified latex particulates of the present invention are particularly useful with pigment based systems. If a pigment is used, the pigment can be a standard pigment that is dispersed by another chemical additive, or can be a self-dispersed pigment having a chemical group covalently attached or physically attached to the surface thereof. Examples of such physical attachment or chemical tethering can be through hydrophobic-hydrophilic attraction, ionic association, covalent bonding, physical adsorption, or other known attachment mechanism. The pigment can be of any color, and the present invention embodiments are not limited to specific pigments. Further, the pigments can be neutral, cationic, anionic, hydrophilic, and/or hydrophobic, without limitation.

Examples of black pigments that can be used include carbon pigments. The carbon pigment can be almost any commercially available carbon pigment that provides acceptable optical density and print characteristics. Carbon pigments suitable for use in the present invention include, without limitation, carbon black, graphite, vitreous carbon, charcoal, and combinations thereof. Such carbon pigments can be manufactured by a variety of known method such as a channel method, a contact method, a furnace method, an acetylene method, or a thermal method, and are commercially available from such vendors as Cabot Corporation, Columbian Chemicals Company, Degussa AG, and E.I. DuPont de Nemours and Company. Suitable carbon black pigments include, without limitation, Cabot pigments such as MONARCH 1400, MONARCH 1300, MONARCH 1100, MONARCH 1000, MONARCH 900, MONARCH 880, MONARCH 800, MONARCH 700, CAB-O-JET 200, and CAB-O-JET 300; Columbian pigments such as RAVEN 7000, RAVEN 5750, RAVEN 5250, RAVEN 5000, and RAVEN 3500; Degussa pigments such as Color Black FW 200, RAVEN FW 2, RAVEN FW 2V, RAVEN FW 1, RAVEN FW 18, RAVEN S160, RAVEN FW S170, Special Black 6, Special Black 5, Special Black 4A, Special Black 4, PRINTEX U, PRINTEX 140U, PRINTEX V, and PRINTEX 140V; and TIPURE R-101 available from Dupont. The above list of pigments includes unmodified pigment particulates, small molecule attached pigment particulates, and polymer-dispersed pigment particulates.

A wide variety of colored pigments can be used with the present invention, therefore the following listing is not intended to be limiting. The following color pigments are available from Cabot Corp.: CABO-JET 250C, CABO-JET 260M, and CABO-JET 270Y. The following color pigments are available from BASF Corp.: PALIOGEN Orange, HELIOGEN Blue L 6901F, HELIOGEN Blue NBD 7010, HELIOGEN Blue K 7090, HELIOGEN Blue L 7101F, PALIOGEN Blue L 6470, HELIOGEN Green K 8683, and HELIOGEN Green L 9140. The following pigments are available from Ciba-Geigy Corp.: CHROMOPHTAL Yellow 3G, CHROMOPHTAL Yellow GR, CHROMOPHTAL Yellow 8G, IGRAZIN Yellow 5GT, IGRALITE Rubine 4BL, MONASTRAL Magenta, MONASTRAL Scarlet, MONASTRAL Violet R, MONASTRAL Red B, and MONASTRAL Violet Maroon B. The following pigments are available from Heubach Group: DALAMAR Yellow YT-858-D and HEUCOPHTHAL Blue G XBT-583D. The following pigments are available from Hoechst Specialty Chemicals: Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM Yellow HR, NOVOPERM Yellow FGL, Hansa Brilliant Yellow 10 GX, Permanent Yellow G3R-01, HOSTAPERM Yellow H4G, HOSTAPERM Yellow H3G, Hostaperme Orange GR, HOSTAPERM Scarlet GO, and Permanent Rubine F6B. The following pigments are available from Mobay Corp.: QUINDO Magenta, INDOFAST Brilliant Scarlet, QUINDO Red R6700, QUINDO Red R6713, and INDOFAST Violet. The following pigments are available from Sun Chemical Corp.: L74-1357 Yellow, L75-1331 Yellow, and L75-2577 Yellow.

Examples of dispersant polymers that can be used include water-soluble polymeric resin(s), as long as the resin(s) function to stabilize and/or disperse the pigment in solution (attached or unattached). A polymeric resin that can be used includes those having a weight average molecular weight in a range of 1,000 Mw to 30,000 Mw, or any incremental range therein. For example, in a more detailed embodiment, the polymer can have a weight average molecular weight in a range from 3,000 Mw to 10,000 Mw. Specifically, the resin can be a polymer, block copolymer, tri-block copolymer, graft copolymer, random copolymer, or the like. Additionally, the polymer can include one or more monomers with characteristics such as hydrophilic, hydrophobic, neutral, cationic, anionic, amphoteric, and combinations thereof. Exemplary monomers that can be used to form such polymers and copolymers include, without limitation, styrene, styrene derivatives, vinylnaphthalene, vinylnaphthalene derivatives, aliphatic alcohol esters, of α-, β-ethylenically unsaturated carboxylic acids, acrylic acid, acrylic acid derivatives, maleic acid, maleic acid derivatives, itaconic acid, itaconic acid derivatives, fumaric acid and fumaric acid derivative, and the like, and combinations thereof.

Examples of suitable anionic dyes include a large number of water-soluble acid and direct dyes. Specific examples of anionic dyes include Direct Yellow 86, Acid Red 249, Direct Blue 199, Direct Black 168, Reactive Black 31, Direct Yellow 157, Reactive Yellow 37, Acid Yellow 23, Reactive Red 180, Acid Red 52, Acid Blue 9, Direct Red 227, Acid Yellow 17, Direct Blue 86, Reactive Red 4, Reactive Red 56, Reactive Red 31, and Direct Yellow 132; Aminyl Brilliant Red F-B (Sumitomo Chemical Co.); the Duasyn line of “salt-free” dyes available from Hoechst; mixtures thereof; and the like. Further examples include Bernacid Red 2BMN, Pontamine Brilliant Bond Blue A, BASF X-34, Pontamine, Food Black 2, Levafix Brilliant Red E-4B (Mobay Chemical), Levafix Brilliant Red E-6BA (Mobay Chemical), Pylam Certified D&C Red #28 (Acid Red 92, Pylam), Direct Brill Pink B Ground Crude (Crompton & Knowles), Cartasol Yellow GTF Presscake (Sandoz, Inc.), Tartrazine Extra Conc. (FD&C Yellow #5, Acid Yellow 23, Sandoz, Inc.), Cartasol Yellow GTF Liquid Special 110 (Sandoz, Inc.), D&C Yellow #10 (Yellow 3, Tricon), Yellow Shade 16948 (Tricon), Basacid Black X34 (BASF), Carta Black 2GT (Sandoz, Inc.), Neozapon Red 492 (BASF), Orasol Red G (Ciba-Geigy), Direct Brilliant Pink B (Crompton-Knolls), Aizen Spilon Red C-BH (Hodagaya Chemical Company), Kayanol Red 3BL (Nippon Kayaku Company), Levanol Brilliant Red 3BW (Mobay Chemical Company), Levaderm Lemon Yellow (Mobay Chemical Company), Aizen Spilon Yellow C-GNH (Hodagaya Chemical Company), Spirit Fast Yellow 3G, Sirius Supra Yellow GD 167, Cartasol Brilliant Yellow 4GF (Sandoz), Pergasol Yellow CGP (Ciba-Geigy), Orasol Black RL (Ciba-Geigy), Orasol Black RLP (Ciba-Geigy), Savinyl Black RLS (Sandoz), Dermacarbon 2GT (Sandoz), Pyrazol Black BG (ICI Americas), Morfast Black Conc A (Morton-Thiokol), Diazol Black RN Quad (ICI Americas), Orasol Blue GN (Ciba-Geigy), Savinyl Blue GLS (Sandoz, Inc.), Luxol Blue MBSN (Morton-Thiokol), Sevron Blue 5GMF (ICI Americas), and Basacid Blue 750 (BASF); Levafix Brilliant Yellow E-GA, Levafix Yellow E2RA, Levafix Black EB, Levafix Black E-2G, Levafix Black P-36A, Levafix Black PN-L, Levafix Brilliant Red E6BA, and Levafix Brilliant Blue EFFA, all available from Bayer; Procion Turquoise PA, Procion Turquoise HA, Procion Turquoise Ho5G, Procion Turquoise H-7G, Procion Red MX-5B, Procion Red MX 8B GNS, Procion Red G, Procion Yellow MX-8G, Procion Black H-EXL, Procion Black P-N, Procion Blue MX-R, Procion Blue MX-4GD, Procion Blue MX-G, and Procion Blue MX-2GN, all available from ICI Americas; Cibacron Red F-B, Cibacron Black BG, Lanasol Black B, Lanasol Red 5B, Lanasol Red B, and Lanasol Yellow 46, all available from Ciba-Geigy; Baslien Black P-BR, Baslien Yellow EG, Baslien Brilliant Yellow P-3GN, Baslien Yellow M-6GD, Baslien Brilliant Red P-3B, Baslien Scarlet E-2G, Baslien Red E-B, Baslien Red E-7B, Baslien Red M-5B, Baslien Blue E-R, Baslien Brilliant Blue P-3R, Baslien Black P-BR, Baslien Turquoise Blue P-GR, Baslien Turquoise M-2G, Baslien Turquoise E-G, and Baslien Green E-6B, all available from BASF; Sumifix Turquoise Blue G, Sumifix Turquoise Blue H-GF, Sumifix Black B, Sumifix Black H-BG, Sumifix Yellow 2GC, Sumifix Supra Scarlet 2GF, and Sumifix Brilliant Red 5BF, all available from Sumitomo Chemical Company; Intracron Yellow C-8G, Intracron Red C-8B, Intracron Turquoise Blue GE, Intracron Turquoise HA, and Intracron Black RL, all available from Crompton and Knowles, Dyes and Chemicals Division; Pro-Jet 485 (a copper phthalocyanine); Magenta 377; mixtures thereof, and the like. This list is intended to be merely exemplary, and should not be considered limiting.

Regarding the liquid vehicles and other additives that can be included in the formulations and methods of present invention, it is understood that the enumerated components are exemplary and do not limit the scope of vehicle components that can be used. For example, in some embodiments of the present invention, it may be favorable for the liquid vehicle to comprise water-soluble organic solvents or other co-solvents, and other additives as part of the liquid medium. The balance of any embodiment formulation can be purified water, or other vehicle component known in the art.

The water-soluble organic solvents and/or co-solvents that can be used in the present invention include, but is not limited to, dimethylformamide, dimethylacetamide, acetone, tetrahydrofuran, dioxane, polyethylene glycol, polypropylene glycol, ethylene glycol, propylene glycol, butylene glycol, 1,2-hexanediol, triethylene glycol, 1,2,6-hexanetriol, thiodiglycol, hexylene glycol, diethylene glycol, ethylene glycol methyl ether, diethylene glycol monomethyl ether, triethylene glycol monomethyl ether, ethanol isopropyl alcohol, n-butyl alcohol, isobutyl alcohol, glycerol, n-methyl-2-pyrrolidone, 1,3-dimethylimidazolidinone, triethanolamine, sulfolane, dimethyl sulfoxide, and the like, as well as other amines, ketones, ethers, polyalkylene glycols, alkylene glycols, lower alkyl ethers of polyhydric alcohols, monohydric alcohols, and combinations thereof.

Additionally, the liquid vehicle can comprise humectants. Humectants can be present to enhance the longevity of solution and solubility characteristics, which can be maintained by retention of moisture within the liquid vehicle. Examples of humectants include, but are not limited to, nitrogen-containing compounds such as urea, thiourea, ethylene urea, alkylurea, alkylthiourea, dialkylurea, dialkylthiourea; sugars such as 1-deoxy-D-galactitol, mannitol, and inositol, and combinations thereof.

The liquid vehicle can also comprise solution characteristic modifiers such as viscosity modifiers, pH adjusters, preservatives, various types of surfactant, antioxidants, and evaporation accelerators. Examples of surfactants that can be used include primary, secondary, and tertiary amine salt compounds such as hydrochloric acid salts, acetic acid salts of laurylamine, coconut amine, stearylamine, rosin amine; quaternary ammonium salt type compounds such as lauryltrimethylammonium chloride, cetyltrimethylammonium chloride, benzyltributylammonium chloride, benzalkonium chloride, etc.; pyridinium salty type compounds such as cetylpyridinium chloride, cetylpyridinium bromide, etc.; nonionic surfactant such as polyoxyethylene alkyl ethers, polyoxyethylene alkyl esters, acetylene alcohols, acetylene glycols; and other surfactants such as 2-heptadecenyl-hydroxyethylimidazoline, dihydroxyethylstearylamine, stearyldimethylbetaine, and lauryidihydroxyethylbetaine; and combinations thereof. Fluorosurfactants can also be used such as those previously known in the art.

pH adjustors that can be used comprise base agents such as sodium hydroxide, lithium hydroxide, sodium carbonate, ammonium carbonate ammonia sodium acetate, ammonium acetate, morpholine, monoethanolamine, diethanolamine, triethanolamine, ethylmonoethanolamine, n-butyldiethanolamine, di-n-butylethanolamine, monoisopropanolamine, diisopropanolamine, and triisopropanolamine, and the like as well as combinations thereof. Additionally, pH adjustors can also comprise acidic agents that can be selected from the list of acidic crashing agents.

Consistent with the formulation of this invention, various other additives can be used to optimize the properties of the ink composition for specific applications. Examples of these additives are those added to inhibit the growth of harmful microorganisms. These additives may be biocides, fungicides, and other microbial agents, which are routinely used in liquid vehicle formulations. Examples of suitable microbial agents include, but are not limited to, Nuosept (Nudex, Inc.), Ucarcide (Union carbide Corp.), Vancide (R.T. Vanderbilt Co.), Proxel (ICI America), and combinations thereof.

Sequestering agents, such as EDTA (ethylene diamine tetra acetic acid) and the like, may be included to eliminate the deleterious effects of heavy metal impurities.

Additionally, solids (either dissolved in the liquid vehicle or dispersed therein) can also be present in the formulations of the present invention, and can include binders, latex particulates, UV curable materials, plasticizers, pigments (other than the colorant), etc.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention.

### Example 1

### Preparation of Phenol-Containing Polymerizable Monomer (X) as shown in Formula 4

Reaction of 4-vinylbenzoic acid chloride (VII) with ethylene glycol gives a first monomer hydroxyethyl 4-vinylbenzoic acid ester (VIII), which is further coupled with 4-hydroxybenzoic acid (IX) in the presence of a coupling agent, such as CDI (N,N′-carbonyldiimidazole) to give the phenol containing second monomer (X). The second monomer (X) includes a polymerizable vinyl group and free radical scavenging 4-hydroxyphenyl group.

### Example 2

### Preparation of Amine-Containing Polymerizable Monomer (XVIII) as shown in Formula 6

Reaction of 1-piperazineethanol (XV) with di-tert-butyl dicarbonate generates intermediate (XVI), which is further reacted with acryoyl chloride to give a protected monomer (XVII). The protected monomer can then be deprotected in the presence of trifluoroacetic acid to give a second amine containing monomer (XVIII), which includes a polymerizable vinyl group and free radical scavenging piperazine group.

### Example 3

### Preparation of Phenol-Containing Latex Particulates

The phenol containing polymerizable monomer (X) (10 wt %) of Example 1 is mixed with methyl methacrylate (42 wt %), hexyl acrylate (42 wt %), and methacrylic acid (6 wt %) to form a monomer mixture. Though a cross-linker is not used in this examples, it is to be noted that a cross-linker can be used, e.g., ethylene glycol dimethacrylate (0.05 to 10 wt %). The monomer mixture (about 35 wt %) is emulsified with Rhodafac RS 710 surfactant (2.5 wt % relative to the monomers) and a balance of water. The monomer emulsion is added dropwise to hot water containing a horseradish peroxidase, hydrogen peroxide, and 2,4-pentanedione as initiator (about 0.4 wt % relative to the monomers). The heating is continued for a period of two hours and then cooled to ambient temperature. The latex particulates form within the emulsion.

### Example 4

### Preparation of Amine-Containing Latex Particulates

The amine containing polymerizable monomer (XVIII) (10 wt %) of Example 2 is mixed with methyl methacrylate (42 wt %), hexyl acrylate (42 wt %), and methacrylic acid (6 wt %) to form a monomer mixture. Though a cross-linker is not used in this examples, it is to be noted that a cross-linker can be used, e.g., ethylene glycol dimethacrylate (0.05 to 10 wt %). The monomer mixture (about 35 wt %) is emulsified with Rhodafac RS 710 surfactant (2.5 wt % relative to the monomers) and a balance of water. The monomer emulsion is added dropwise to hot water containing a horseradish peroxidase, hydrogen peroxide, and 2,4-pentanedione as initiator (about 0.4 wt % relative to the monomers). The heating was continued for a period of two hours and then cooled to ambient temperature. The latex particulates form within the emulsion.

### Example 5

### Ink-Jet Ink Preparation

The latex emulsion prepared in accordance with Example 3 (equivalent to 2.5 g solid polymer) is mixed with a nucleophilic dye along with a liquid vehicle (20 g). The liquid vehicle includes water, 2-pyrrolidone, and ethylene glycol. The concentration of the dye is about 3 wt %.

### Example 6

### Ink-Jet Ink Preparation

The latex emulsion prepared in accordance with Example 4 is mixed with a self-dispersed pigment along with a liquid vehicle (20 g). The liquid vehicle includes water, 2-pyrrolidone, and ethylene glycol. The concentration of the pigment is about 3 wt %.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. A method of preparing anti-oxidant-modified latex particulates in a fluid suspension, comprising:
generating an emulsion with a hydrophilic continuous phase and a hydrophobic discontinuous phase, wherein the hydrophobic discontinuous phase includes monomers for polymerization, at least one of the monomers being modified by an anti-oxidant moiety; and
polymerizing the monomers in the hydrophobic discontinuous phase using a biocatalytic polymerization process.

2. The method of claim 1, wherein the anti-oxidant moiety is unprotected.

3. The method of claim 2, wherein the polymerizing step is carried out in mild enough conditions such that no more than about 25 wt % of the monomer modified by the unprotected anti-oxidant moiety is transferred from the hydrophobic discontinuous phase to the hydrophilic continuous phase during polymerization.

4. The method of claim 1, wherein the hydrophobic discontinuous phase includes multiple types of monomers.

5. The method of claim 1, wherein the multiple types of monomers include at least one monomer type that is a support forming monomer that is not modified by an anti-oxidant moiety.

6. The method of claim 1, wherein the biocatalytic polymerization process is carried out using an enzyme which is an oxidoreductase compound.

7. The method of claim 1, wherein the biocatalytic polymerization process is carried out using an enzyme selected from the group of horseradish peroxidase, soybean and/or other legume peroxidase, laccase, α-chymotrypsin, bilirubin oxidase, and a combination thereof.

8. The method of claim 7, where the enzyme is horseradish peroxidase.

9. The method of claim 7, wherein the biocatalytic polymerization is also carried out in the presence of at least one of hydrogen peroxide and acetylacetone.

10. A method of preparing an ink-jet ink, comprising:
preparing anti-oxidant-modified latex particulates as in claim 1; and
formulating the anti-oxidant-modified latex particulates in an ink-jet ink composition by combining the anti-oxidant-modified latex particulates with a colorant.

11. The method of claim 10, wherein the hydrophilic continuous phase is mixed with other ingredients to form a liquid vehicle for the ink-jet ink.

12. A method of preparing a coating composition suitable for overcoating an ink-jet ink-produced image, comprising:
preparing anti-oxidant-modified latex particulates as in claim 1; and
formulating the anti-oxidant-modified latex particulates in an ink-jettable coating composition.

13. The method of claim 12, wherein the hydrophilic continuous phase is mixed with other ingredients to form a liquid vehicle for the coating composition.

14. A latex, comprising:
a liquid medium; and
anti-oxidant-modified latex particulates suspended in the liquid medium, said anti-oxidant-modified latex particulates prepared by a biocatalytic polymerization process, wherein at least one monomer used in the biocatalytic polymerization process is modified by an anti-oxidant moiety.

15. The latex of claim 14, wherein the liquid medium includes residual amounts of enzyme used in the biocatalytic polymerization process after formation of the anti-oxidant-modified latex particulates.

16. The latex of claim 14, wherein the anti-oxidant modified latex particulates are prepared without the use of protectant groups on the anti-oxidant moiety, resulting in a latex free from protectant groups in the fluid medium.

17. The latex of claim 14, wherein no more than about 25 wt % of the monomer modified by an anti-oxidant moiety is present in the liquid medium immediately after polymerization.

18. The latex of claim 14, wherein the anti-oxidant-modified latex particulates are prepared using multiple types of monomers, including at least one support forming monomer that is not modified by the anti-oxidant moiety.

19. The latex of claim 14, wherein the biocatalytic polymerization process is carried out using an enzyme which is an oxidoreductase compound.

20. The latex of claim 14, formulated with a colorant to form an ink-jet ink.
